(19) United States
(12) Patent Application Publication
(10) Pub. No.: US 2016/0145894 A1
(43) Pub. Date: May 26, 2016

(54) LATCH SYSTEM FOR DOOR

(71) Applicant: WOOBO TECH CO., LTD., Pyeongtaek-si (KR)

(72) Inventor: Hae II Jeong, Incheon (KR)

(21) Appl. No.: 14/901,236

(22) PCT Filed: Mar. 13, 2015
(86) PCT No.: PCT/KR2015/002477

§ 371 Date: Dec. 28, 2015

(30) Foreign Application Priority Data
Mar. 14, 2014 (KR) 10-2014-0030359

(51) Int. Cl. E05B 15/00

(52) U.S. Cl. CPC E05B 15/0046

(57) ABSTRACT

This invention relates to a latch system for a door, and more particularly, to a latch system for a door, in which a locking member configured to lock a latch includes a sliding member slidably installed at a housing.

### TECHNICAL FIELD

This invention relates to a latch system for a door, and more particularly, to a latch system for a door, in which a locking member configured to lock a latch includes a sliding member slidably installed at a housing.

### BACKGROUND ART

In a door latch system, as described in Korean Patent No. 10-1091658, a latch and a link which locks the latch are installed at a case.

However, such a conventional door latch system includes many links to perform various functions. Due to the many components, there are some problems in that manufacturing cost is increased, and an assembling operation becomes complicated.

### SUMMARY OF INVENTION

### Technical Problem

The present invention is directed to a latch system for a door, which is capable of remarkably reducing the number of components.

### Solution to Problem

According to an aspect of the present invention, there is provided a latch system for a door including a housing, a latch rotatably installed at the housing, and a locking member installed at the housing to lock the latch, wherein the locking member includes a sliding member slidably installed at the housing, and the latch is installed to be rotatable, and the sliding member is installed to be linearly movable.

A lever connecting part connected to a door lever to slide the sliding member may be connected to the sliding member, and a moving space in which the lever connecting part is movable in a pulling direction may be formed at the sliding member. The latch may be disposed at one side of the sliding member, a first safety device may be rotatably installed at the housing, and the first safety device may be disposed at the other side of the sliding member to fix the door lever, even when the door lever is pulled.

The lever connecting part may include a door-in-lever connecting part and a door-out-lever connecting part, and a second safety device may be rotatably installed at the housing, and a first stopping part caught by the sliding member and a second stopping part caught by the second safety device may be formed at the door-in-lever connecting part. And the latch system may further include a second safety driving part configured to rotate the second safety device.

The locking member may further include a rotating member rotatably installed at the housing and a lever connecting part connected to a door lever, a locking groove may be formed at the latch, a locking protrusion inserted into the locking groove may be formed at the rotating member, and the lever connecting part may be connected to the rotating member and the sliding member so as to rotate the rotating member and to slide the sliding member.

The latch system may further include a latch driving part configured to rotate the latch to a locking position, and may include a first sensor configured to detect whether the latch is rotated by a predetermined angle, and a control part configured to receive a signal from the first sensor and to rotate the latch to the locking position through the latch driving part. A protrusion may be formed at the latch, a stopping part caught by the protrusion may be formed at the latch driving part, and a second sensor configured to detect whether the stopping part is returned to a releasing position and a third sensor configured to detect whether the stopping part is rotated to a locking position may be provided. The latch system may further include a fourth sensor configured to detect whether the door lever is operated, and when an operation of the door lever is detected through the fourth sensor, the control part may return the latch to the releasing position even though the latch driving part is being operated.

### Advantageous Effects of Invention

The latch system of the door of the present invention, as described above, has the following effects.

The locking member which locks the latch includes the sliding member which is slidably installed at the housing, and thus the number of components can be remarkably reduced.

Since the locking member is slidably installed at the housing, the locking member can be formed in the thick bar shape, and thus the durability of the system can be further enhanced.

Since the lever connecting part which is connected with the door lever to slide the sliding member is connected to the sliding member, and the sliding member has the moving space in which the lever connecting part is movable in the pulling direction when the door-out-lever connecting part is pulled after the safety device is locked, the wire can be prevented from being bent, and position correction can be performed.

The latch is disposed at one side of the sliding member, and the first safety device is rotatably installed at the housing, and the first safety device is disposed at the other side of the sliding member to fix the sliding member even when the door lever is pulled. Therefore, when the vehicle is run at the high speed, or it is necessary, the locking state of the latch is maintained even when the door lever is pulled, and thus the door is not opened.

Also, the lever connecting part includes the door-in-lever connecting part and the door-out-lever connecting part, the second safety device is rotatably installed at the housing, the first stopping part which is caught by the sliding member and the second stopping part which is caught by the second safety device are formed at the door-in-lever connecting part, and thus the locked state of the latch is released by the lever disposed at the outer side of the door, but not released by the lever disposed at the inner side of the door. Therefore, an accident in which a child pulls the door lever and opens the door can be prevented.

The second safety device driving part which rotates the second safety device is further provided, and thus the driver or the adult can easily rotate and operate the second safety device at the front side of the vehicle.

The first sensor which detects whether the latch is rotated at the predetermined angle and the control part which receives the signal from the first sensor and rotates the latch to the locking position through the latch driving part are provided, and thus the door can be closed even when only slightly closed by the user.

The protrusion is formed at the latch, and the stopping part which is caught by the protrusion is formed at the latch driving part and the third sensor which detects whether the stopping part is rotated to the locking position and the second sensor which detects whether the stopping part is returned to the releasing position are provided, and thus the door can be smoothly automatically closed.

The fourth sensor which detects whether the door lever is operated is further provided, and when the operation of the lever is detected through the sensor, the control part returns the latch to the releasing position even though the latch driving part is being operated, thus, if clothing or a person is caught in the door, the user may pull the door lever, the locked state of the latch is released, and a safety accident can be prevented.

### BRIEF DESCRIPTION OF DRAWINGS

The above and other objects, features and advantages of the present invention will become more apparent to those of ordinary skill in the art by describing in detail exemplary embodiments thereof with reference to the accompanying drawings, in which:

FIG. 1 is a perspective view of a latch system for a door in accordance with a first embodiment of the present invention;

FIG. 2 is an exploded perspective view of FIG. 1;

FIG. 3 is a front view illustrating a state in which a second housing is removed from the latch system for the door of FIG. 1;

FIG. 4 is a rear view of the latch system for the door of FIG. 1;

FIG. 5 is a front view illustrating a state in which a first safety device of the latch system for the door of FIG. 1 is operated (while the second housing is removed);

FIG. 6 is a perspective view of a second safety device of the latch system for the door of FIG. 1;

FIG. 7a is an enlarged perspective view illustrating a state in which the second safety device of the latch system for the door of FIG. 1 is operated;

FIG. 7b is an enlarged perspective view illustrating a state in which the second safety device of the latch system for the door of FIG. 1 is not operated;

FIG. 8a is a front view illustrating a state in which the second housing is removed from the latch system for the door of FIG. 1 (while the door is opened);

FIG. 8b is a front view illustrating the state in which the second housing is removed from the latch system for the door of FIG. 1 (while the door is primarily locked);

FIG. 8c is a front view illustrating the state in which the second housing is removed from the latch system for the door of FIG. 1 (while the door is secondly locked);

FIG. 8d is a front view illustrating the state in which the second housing is removed from the latch system for the door of FIG. 1 (while a door lever is pulled by a user, and thus a sliding member is pulled and then separated from the latch);

FIG. 9 is a perspective view of a latch system for a door in accordance with a second embodiment of the present invention;

FIG. 10 is an exploded perspective view of the latch system for the door of FIG. 9;

FIG. 11 is a front view illustrating a state in which a second housing is removed from the latch system for the door of FIG. 9;

FIG. 12a is a front view illustrating the state in which the second housing is removed from the latch system for the door of FIG. 9 (while the door is opened);

FIG. 12b is a front view illustrating the state in which the second housing is removed from the latch system for the door of FIG. 9 (while the door is primarily locked);

FIG. 12c is a front view illustrating the state in which the second housing is removed from the latch system for the door of FIG. 9 (while the door is secondly locked);

FIG. 13 is a perspective view of a latch system for a door in accordance with a third embodiment of the present invention;

FIG. 14 is a rear perspective view of the latch system for the door of FIG. 13;

FIG. 15 is an exploded perspective view of the latch system for the door of FIG. 13;

FIG. 16 is a front view illustrating a state in which the second is separated from the latch system for the door of FIG. 13;

FIG. 17a is a front view illustrating the state in which the second housing is removed from the latch system for the door of FIG. 13 (while the door is opened);

FIG. 17b is a front view illustrating the state in which the second housing is removed from the latch system for the door of FIG. 13 (while the door is primarily locked);

FIG. 17c is a front view illustrating the state in which the second housing is removed from the latch system for the door of FIG. 13 (while the door is secondly locked);

FIG. 17d is a front view illustrating the state in which the second housing is removed from the latch system for the door of FIG. 13 (while a door lever is pulled by a user, and thus a sliding member is pulled and then separated from the latch);

FIG. 18 is a perspective view of a latch system for a door in accordance with a fourth embodiment of the present invention;

FIG. 19 is an exploded perspective view of the latch system for the door of FIG. 18;

FIG. 20 is a front view illustrating a state in which the second is separated from the latch system for the door of FIG. 18;

FIG. 21a is a front view illustrating the state in which the second housing is removed from the latch system for the door of FIG. 18 (while the door is opened);

FIG. 21b is a front view illustrating the state in which the second housing is removed from the latch system for the door of FIG. 18 (while the door is primarily locked); and

FIG. 21c is a front view illustrating the state in which the second housing is removed from the latch system for the door of FIG. 18 (while the door is secondly locked).

### DETAILED DESCRIPTION OF EMBODIMENT

Hereinafter, one exemplary embodiment of the present invention will be described in detail with respect to the accompanying drawings.

For reference, the elements of the present invention which are the same as those in the related art will refer to the related art, and the detailed description thereof will be omitted.

### First Embodiment

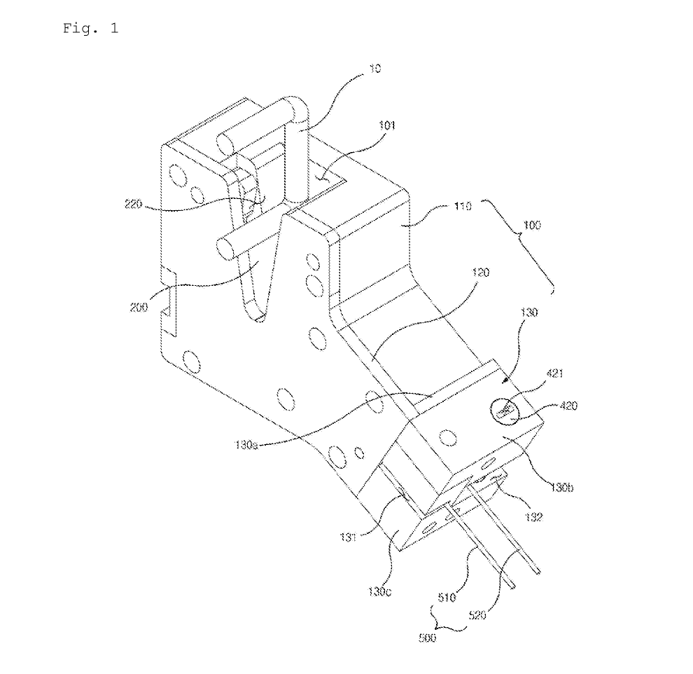

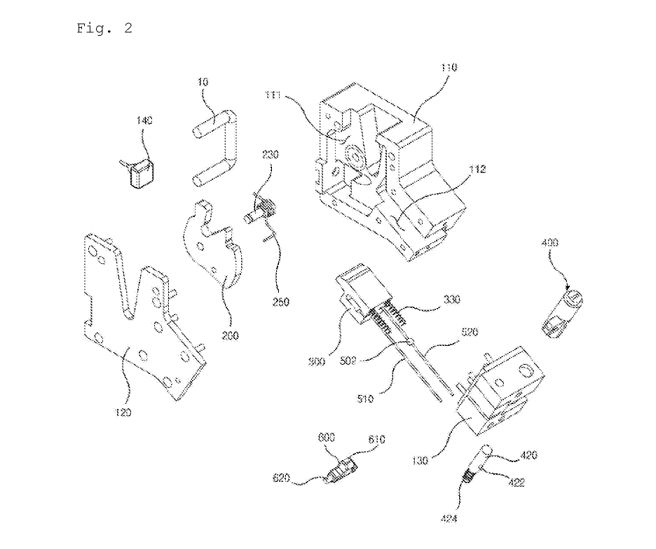

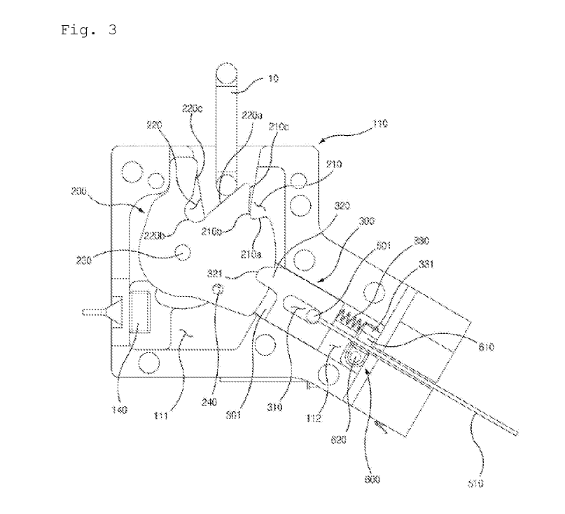

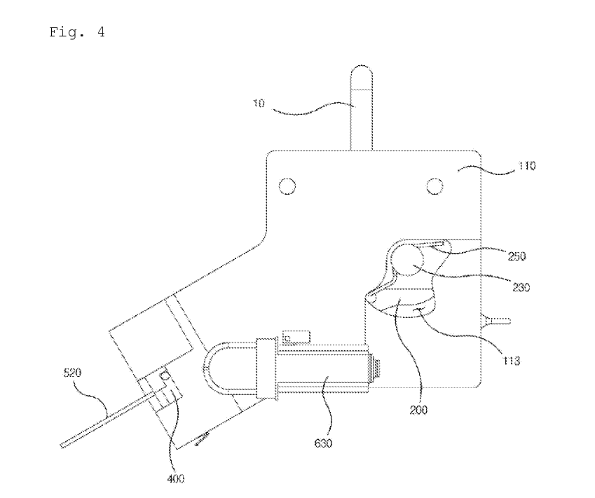

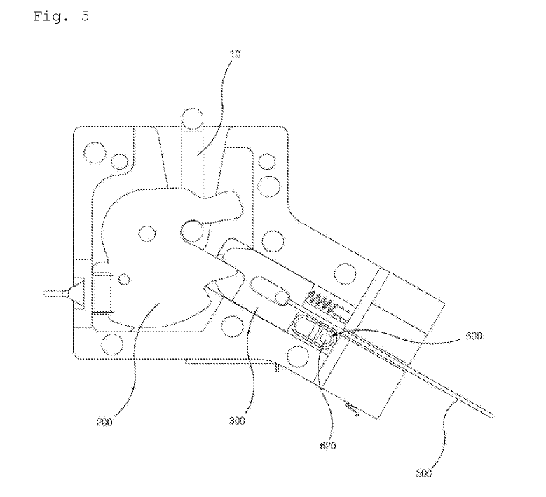

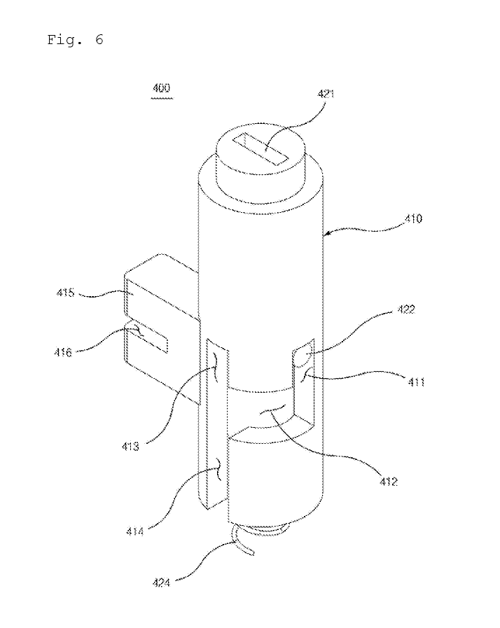

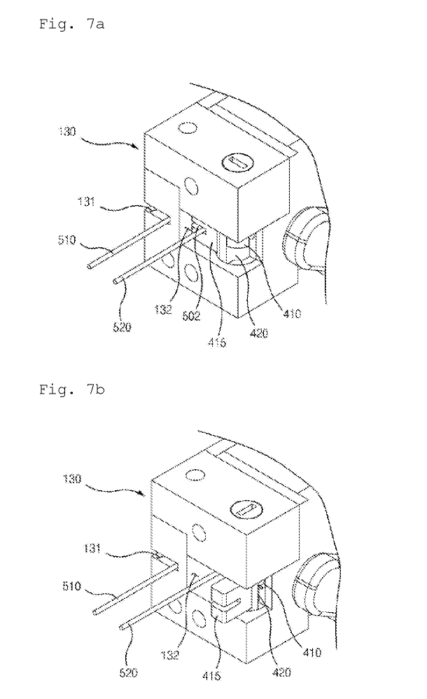

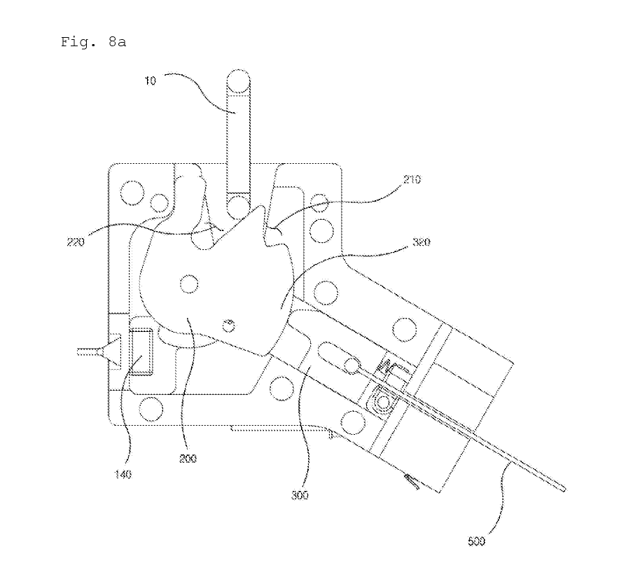

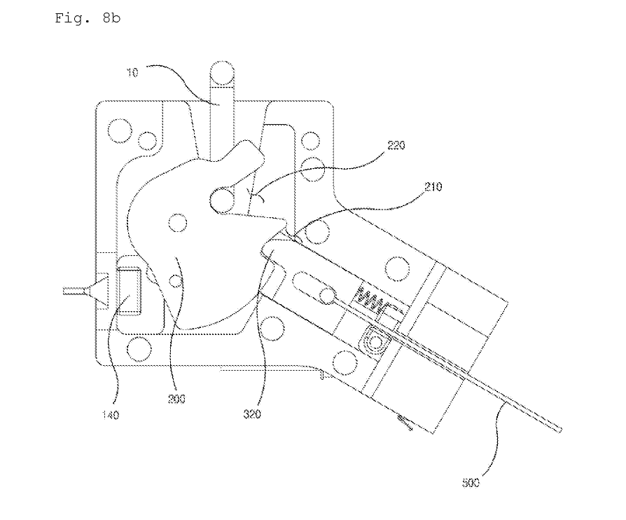

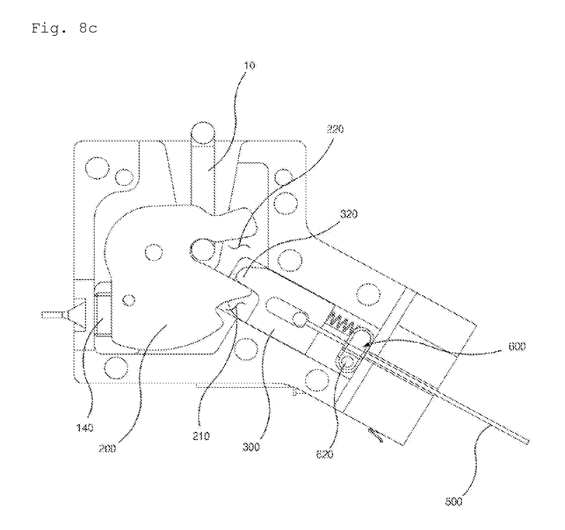

As illustrated in FIGS. 1 to 8, a latch system for a door in accordance with a first embodiment of the present invention includes a housing 100, a latch 200 which is rotatably installed at the housing 100, and a locking member which is installed at the housing 100 to lock the latch 200. The locking member includes a sliding member 300 which is slidably installed at the housing 100, the latch 200 is rotatably installed, and the sliding member 300 is installed to be linearly movable.

The housing 100 includes a first housing 110, a second housing 120 which is disposed in front of the first housing 110, and a third housing 130 which is disposed at side parts of the first and second housings 110 and 120.

A link insertion groove 101 in which a link 10 connected to a door (not shown) is inserted is formed at upper and front portions of the housing 100.

The first housing 110 is formed in a block shape, and a latch seating groove 111 (which will be described below) in which the latch 200 is seated and a locking member seating groove 112 (which will be described below) in which the locking member is seated are formed at a front surface thereof.

An upper portion of the latch seating groove 111 is formed to be opened and thus to be in communication with the link insertion groove 101.

The locking member seating groove 112 is formed in a left and right direction to be in communication with the latch seating groove 111.

The locking member seating groove 112 is formed to be deeper than the latch seating groove 111.

The locking member seating groove 112 is formed longer than the sliding member 300 so that the sliding member is slidable therein.

Also, a guide groove is formed at the first housing 110 in a left and right direction to be in communication with the locking member seating groove 112.

Furthermore, a spring through-hole 113 is formed at the first housing 110 in a forward and backward direction.

The spring through-hole 113 is formed to be in communication with the latch seating groove 111, and disposed at a lower side of the latch seating groove 111.

A bumper member 140 is installed at a lower portion of an inner wall of the first housing 110 to be disposed in the latch seating groove 111.

The bumper member 140 serves to prevent a clearance when the latch 200 is locked to the locking member.

The second housing 120 is formed in a plate shape, and installed at a front surface of the first housing 110 through a bolt or the like.

The third housing 130 may include a plate-shaped first member 130a, a second member 130b which is disposed at an upper portion of a side part of the first member 130a, and a third member 130c which is disposed at a lower portion of the side part of the first member 130a. The second member 130b is formed in a 180°-rotated L-shape (“┐” shape), and the third member 130c is formed in a L-shape. The first, second and third members 130a, 130b and 130c are coupled with each other by a bolt or the like.

A first slit 131 through which a door-out-lever connecting part 510 (which will be described below) passes is formed at a front side of the third housing 130 in a left and right direction.

A front side of the first slit 131 is formed to be opened.

A lever connecting part passing-though part 132 through which a door-in-lever connecting part 520 (which will be described below) passes is formed at a rear side of the third housing 130 in the left and right direction.

The first slit 131 and the lever connecting part passing-though part 132 are formed to be in communication with the locking member seating groove 112.

Also, a safety device installing hole is formed at a rear side of the third housing 130 in an up and down direction to be in communication with the lever connecting part passing-though part 132.

The latch 200 is installed at the first housing 110 to be disposed in the latch seating groove 111.

The latch 200 is rotatably installed at the first housing 110 through a latch rotating shaft 230.

The latch 200 is formed in a plate shape.

First and second locking grooves 210 and 220 are continuously formed at an outer circumferential surface of the latch 200.

The first locking groove 210 is surrounded by a first surface 210a which is formed to be flat, a second surface 210b which is vertically formed on the first surface 210a, and a third surface 210c which is continuously formed on an upper portion of the second surface 210b to be inclined.

The first surface 210a and the second surface 210b are formed to correspond to a shape of a locking protrusion 320.

The third surface 210c has a great inclination angle with respect to the second surface 210b to be disposed at an upper side than an upper portion 321 of the locking protrusion 320.

The second locking groove 220 is surrounded by a fourth surface 220a which is formed on the third surface 210c to be flat, a fifth surface 220b which is formed in an arc shape to be curved and thus to surround the link 10, and a sixth surface 220c which is formed to be inclined. The sixth surface 220c is formed to be inclined, such that a width thereof is widened toward an outside of the latch 200.

The second locking groove 220 is formed so that front and upper portions thereof are opened.

A spring insertion hole 240 is formed at the latch 200 to pass therethrough in a forward and backward direction.

The second locking groove 220, the first locking groove 210, and the spring insertion hole 240 are sequentially disposed in a rotating direction of the latch 200 when the latch 200 is locked.

A first return spring 250 is provided so that the latch 200 is automatically returned when the latch 200 is unlocked.

The first return spring 250 is installed to be inserted into the latch rotating shaft 230.

One end of the first return spring 250 is fixed to the first housing 110, and the other end is inserted into the spring insertion hole 240.

The other end of the first return spring 250 may be rotated along with the latch 200 through the spring through-hole 113.

The locking member is installed at the first housing 110 to lock the latch 200.

The locking member is a sliding member 300 which is slidably installed at the first housing 110.

A lever connecting part 500 which is connected with a door lever (not shown) to slide the sliding member 300 is connected to the sliding member 300.

A wire is provided as the lever connecting part 500.

The lever connecting part 500 includes the door-out-lever connecting part 510 which is connected with an outer lever of the door and the door-in-lever connecting part 520 which is connected with an inner lever of the door.

A first stopping part 501 which is caught by the sliding member 300 is formed at each end of the door-out-lever connecting part 510 and the door-in-lever connecting part 520. The first stopping part 501 is formed in a ball shape which is integrally formed when the wire is manufactured.

A second stopping part 502 is formed at the door-in-lever connecting part 520 to be disposed between the first stopping part 501 and the door lever.

The sliding member 300 is configured with a bar-shaped block, and a stopping part seating groove 310 in which the first stopping part 501 is seated is formed at front and rear sides thereof to be opened forward and backward.

The stopping part seating groove 310 is formed long in a left and right direction to form a movement space, such that the first stopping part 501 (which will be described below) may be moved in a pulling direction.

A withdrawing hole through which the lever connecting part 500 is withdrawn is formed at a right end of the stopping part seating groove 310.

The stopping part seating groove 310 is disposed in alignment with the first slit 131 so that the lever connecting part 500 may be smoothly pulled when the lever connecting part 500 is pulled.

A locking protrusion 320 which is inserted into the first locking groove 210 or the second locking groove 220 is formed to protrude from an upper portion of a left end of the sliding member 300.

A lower portion of the locking protrusion 320 is horizontally formed, and an edge portion thereof is formed to be rounded.

The upper portion 321 of the locking protrusion 320 is formed to be inclined, such that a width thereof becomes narrow toward an end of the locking protrusion 320.

A connecting rib 301 which connects a lower portion of the left end of the sliding member 300 with the lower portion of the locking protrusion 320 is formed at a rear portion of the sliding member 300, and thus durability of the locking protrusion 320 is further enhanced.

In addition, a spring seating groove is formed at front and rear sides of a right end of the sliding member 300, respectively.

Also, a guide protrusion is formed to protrude from a rear surface of the sliding member 300 in a left and right direction. The guide protrusion is inserted into the guide groove to guide sliding of the sliding member 300.

A second return spring 330 which returns the sliding member 300 applies an elastic force to the sliding member 300 so that the sliding member 300 comes into close contact with the latch 200 when a force is not applied to the sliding member 300 through the lever connecting part 500.

A coil spring is used as the second return spring 330.

The second return spring 330 is disposed above the lever connecting part 500.

A right end of the second return spring 330 is installed at the first member 130a of the third housing 130 and inserted into a spring fixing protrusion 331 disposed in the locking member seating groove 112, and the left end thereof is seated in the spring seating groove of the sliding member 300.

In addition, the latch 200 is disposed at a left side (one side) of the sliding member 300, and a first safety device 600 is disposed at a right side (the other side) of the sliding member 300 so as to be rotatably installed at the first housing 110.

The first safety device 600 is disposed in the locking member seating groove 112.

A lower portion of the first safety device 600 is installed at the first housing 110 to be rotated by a rotating shaft 620.

The rotating shaft 620 is disposed under the lever connecting part 500.

The first safety device 600 has a supporting protrusion 610 which is formed at an upper middle portion of the rotating shaft 620 to have a L-shape or an inverted T-shape (“⊥” shape) and of which an upper portion is disposed between the door-out-lever connecting part 510 and the door-in-lever connecting part 520.

The rotating shaft 620 may be automatically rotated by a first safety device driving part 630 installed at the rear surface of the first housing 110.

For example, the first safety device driving part 630 may be operated when it is detected that a vehicle runs at a predetermined speed or more or when a driver or an adult operates a remote controller or a button.

Like this, when the first safety device driving part 630 is operated, the first safety device 600 is rotated in a counterclockwise direction, and disposed horizontally in a sliding direction of the sliding member 300. Accordingly, the first safety device 600 supports the sliding member 300. Thus, even though a user pulls the door lever, the sliding member 300 is not slid but fixed, and the door is maintained in a locked state.

When the first safety device 600 is released by a speed sensor of the vehicle or an operation of the remote controller or the button, the first safety device driving part 630 rotates the first safety device 600 in a clockwise direction, and the first safety device 600 is disposed vertically to the sliding direction of the sliding member 300. Therefore, the sliding member 300 may be slidable.

A second safety device 400 is installed at the third housing 130 to be inserted into a safety device installing hole. The second safety device 400 is rotatable with respect to the third housing 130.

The second safety device 400 includes a hollow cylinder-shaped first cylindrical member 410 and a second cylindrical member 420 which is inserted into the first cylindrical member 410.

A stopping piece 415 by which the second stopping part 502 is caught is formed to protrude from an outer circumferential surface of the first cylindrical member 410.

A second slit 416 through which the door-in-lever connecting part 520 passes is formed at the stopping piece 415 in a left and right direction so that a front portion thereof is opened.

The first cylindrical member 410 includes a first cut-off groove 411 which is formed in an upward and downward direction, a second cut-off groove 413 which is disposed to be spaced from the first cut-off groove 411 and formed in the upward and downward direction, a connecting groove 412 which is connected to lower portions of the first cut-off groove 411 and the second cut-off groove 413, and a lower groove 414 which is connected with a lower portion of the connecting groove 412.

A stopping rod 422 is formed to protrude from an outer circumferential surface of the second cylindrical member 420.

When the stopping rod 422 is inserted into the first cut-off groove 411 or the second cut-off groove 413 and rotates the second cylindrical member 420, the first cylindrical member 410 is also rotated. Therefore, the stopping piece 415 is also rotated.

A spring 424 is disposed at a lower portion of the second cylindrical member 420 to apply upward an elastic force to the second cylindrical member 420.

A tool groove 421 is formed at an upper portion of the first cylindrical member 410 so that a tool or the like is inserted therein. In the case in which the second safety device 400 is operated, when the tool is inserted into the tool groove 421, and then pushes and rotates the second cylindrical member 420, the second cylindrical member 420, the first cylindrical member 410, and the stopping piece 415 are rotated. When the stopping piece 415 is rotated, the stopping piece 415 is caught by the first member 130a of the third housing 130 and thus restricted not to be rotated more than a predetermined angle.

Therefore, the door-in-lever connecting part 520 is inserted into the second slit 416, and thus, even though the user pulls the lever disposed at an inner side of the door, the second stopping part 502 is caught by the stopping pieces 415, and a lever pulling force is not transmitted to the sliding member 300. Accordingly, the sliding member 300 is not slid, and the door is not opened. However, even though the second safety device 400 is operated, when the user pulls the lever disposed at an outer side of the door, the door is opened.

Also, a second safety device driving part (not shown) which rotates the second safety device 400 in a normal or reverse direction may be further provided.

Also, the tool groove 421 may be formed at the upper portion of the second cylindrical member 420. In this case, the second cylindrical member 420 penetrates the first cylindrical member 410.

A motor or the like is used as the second safety device driving part. The second safety device driving part may turn on/off the second safety device 400 through a remote controller or a button connected with the second safety device driving part.

Through the second safety device driving part, the driver or the adult may easily rotate and operate the second safety device 400 at a front side of the vehicle.

Hereinafter, an operation of the embodiment having the above-described structure will be described.

When the user moves a door handle toward a vehicle body and then inserts the link 10 into the second locking groove 220, the latch 200 is pushed by the link 10 and rotated in the clockwise direction.

Thus, the locking protrusion 320 of the sliding member 300 is inserted into the first locking groove 210 and caught by the first surface 210a. Therefore, the latch 200 is in a locked state and thus may not be rotated in the counterclockwise direction, and the door is in a primarily locked state.

Then, when the user further moves the door toward the vehicle body, the link 10 further rotates the latch 200 in the clockwise direction.

In this process, the locking protrusion 320 is slid on the third surface 210c, inserted into the second locking groove 220, and then caught by (engaged with) the fourth surface 220a. Therefore, the door is in a secondarily locked state which is completely closed. In the secondarily locked state, an opposite side of the latch 200 is supported by the bumper member 140, and the latch 200 and the sliding member 300 are maintained in a state in which the latch 200 and the sliding member 300 come into close contact with each other.

When the lever disposed at the inner side or the outer side of the door is pulled so as to open the door in the locked state, the door-out-lever connecting part 510 or the door-in-lever connecting part 520 is pulled.

Thus, the first stopping part 501 is caught by the sliding member 300, and the sliding member 300 is also pulled along with the lever connecting part 500. The sliding member 300 is slid and then separated from the latch 200. Therefore, the locked state of the latch 200 is released, and the latch 200 is rotated and returned in the counterclockwise direction by the first return spring 250. Thus, the link 10 may be separated from the latch 200, and the door is opened.

Meanwhile, when the latch 200 is rotated and returned in the counterclockwise direction, one side of the latch 200 is caught by the first housing 110, and thus the latch 200 is prevented from being excessively rotated.

Like this, the door may be opened and closed by only the latch 200 and the sliding member 300, and the number of components is remarkably reduced, compared with the conventional link type latch system, and the durability is enhanced, and also the system may have a compact size.

### Second Embodiment

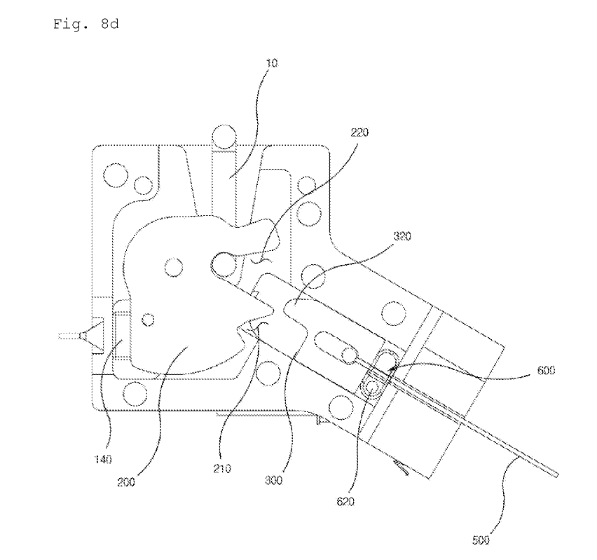

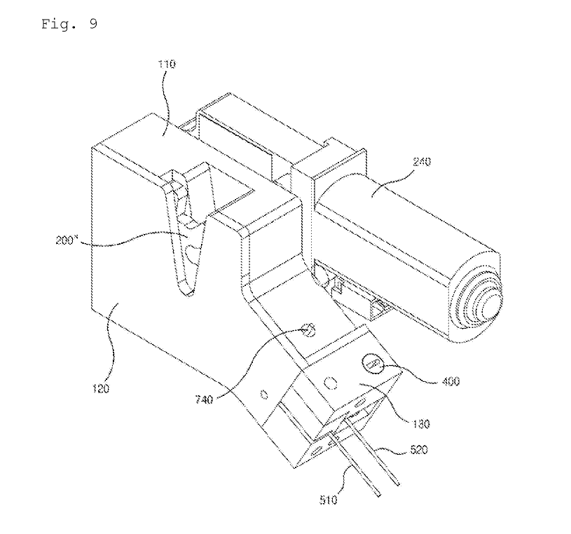

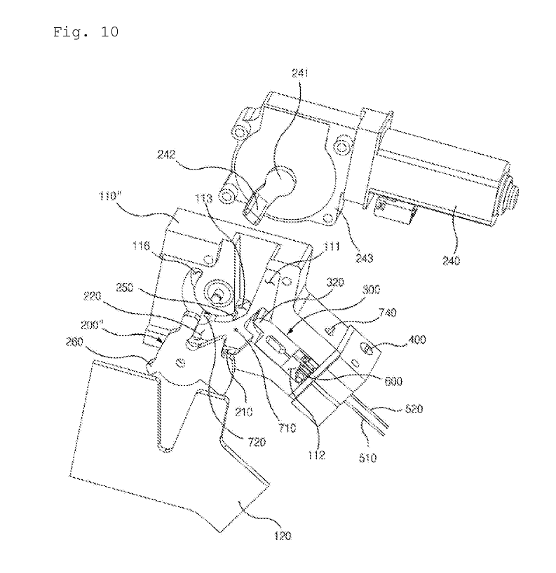

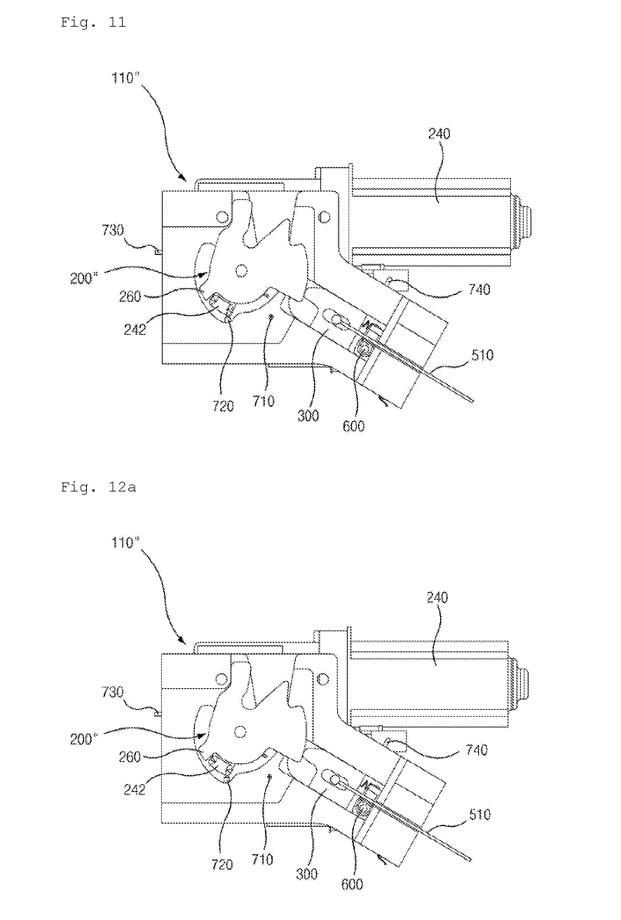

As illustrated in FIGS. 9 to 12, a latch system for a door in accordance with a second embodiment of the present invention further includes a latch driving part 240′ which rotates a latch 200″ to a locking position.

The illustration and description of the elements of the embodiment which are similar to or the same as those in the first embodiment will be omitted.

A motor or the like is used as the latch driving part 240, and the latch driving part 240 is installed at a rear side of a first housing 110″ by a driving part bracket 243.

A stopping part 242 is formed at a shaft 241 of the latch driving part 240 to protrude forward.

The stopping part 242 is disposed to be radially spaced from the shaft 241.

A reduction gear (not shown) is installed at the shaft 241 of the latch driving part 240.

A stopping part guide groove 116 is formed at a left side of the first housing 110″ to be in communication with the spring through-hole 113.

The stopping part 242 is inserted into the stopping part guide groove 116, and thus movement of the stopping part 242 is guided.

The stopping part guide groove 116 is formed in an arc shape.

A protrusion 260 which is caught by the stopping part 242 is formed to protrude from a left outer circumferential surface of the latch 200.

A first sensor 710 which detects whether the latch 200 is rotated by a predetermined angle (corresponding to the primarily locked state) is further provided.

The first sensor 710 is installed at a front surface of the first housing 110″ to be disposed in the latch seating groove 111.

The first sensor 710 is disposed at a right lower portion of the latch seating groove 111.

Also, a third sensor 730 which detects whether the stopping part 242 is rotated to a secondary locking position is further provided.

The third sensor 730 is disposed above the stopping part guide groove 116 in a left and right direction.

Also, a second sensor 720 which detects whether the stopping part 242 is returned to a releasing position is further provided.

The second sensor 720 is disposed under the stopping part guide groove 116 in an upward and downward direction.

Second and third sensor through-holes through which the second and third sensors 720 and 730 pass are formed at the first housing 110″, and the second and third sensors 720 and 730 are installed at the first housing 110″. Therefore, the second and third sensor through-holes are in communication with the stopping part guide groove 116.

Further, a fourth sensor 740 which detects whether the door lever is operated is further provided. The fourth sensor 740 detects the sliding member 300 and thus detects whether the door lever is operated.

A fourth sensor through-hole through which the fourth sensor 740 passes is formed at the first housing 110″, and the fourth sensor 740 is installed at the first housing 110″. Therefore, the fourth sensor through-hole is in communication with the locking member seating groove 112.

A control part (not shown) receives signals from the first, second, third and fourth sensors 710, 720, 730 and 740 and operates the latch driving part 240.

Hereinafter, a method of controlling the latch system for the door of the embodiment having the above-described structure will be described.

When the user moves the door handle toward the vehicle body, and then inserts the link 10 into the second locking groove 220, the latch 200″ is pushed by the link 10 and rotated in the clockwise direction.

Thus, the locking protrusion 320 of the sliding member 300 is inserted and caught into the first locking groove 210. Like this, when the latch 200″ is rotated to the primarily locked state, that is, when the latch 200″ is rotated by the predetermined angle, the first sensor 710 is covered by the latch 200″. Therefore, the first sensor 710 detects that the latch 200″ is rotated by the predetermined angle and transmits a signal to the control part.

The control part to which the signal is transmitted operates the latch driving part 240 in the normal direction (the clockwise direction). Thus, the stopping part 242 is rotated in the clockwise direction.

Therefore, the protrusion 260 is caught by the stopping part 242 and simultaneously rotated with the stopping part 242. In this process, the locking protrusion 320 is inserted and caught (engaged) into the second locking groove 220. Therefore, the door is in the secondarily locked state which is completely closed.

The control part controls the latch driving part 240 so that the latch 200″ is rotated to the secondary locking position.

Like this, even when the user lightly closes the door, i.e., the user does not apply a force enough to completely close the door, the door may be automatically closed.

Further, the control part may receive the signal from the third sensor 730 and may determine whether the stopping part 242 is rotated to the locking position.

If it is determined that the stopping part 242 is rotated to the locking position, the control part rotates the latch driving part 240 in the reverse direction (the counterclockwise direction) and returns the stopping part 242.

Therefore, a connection between the latch driving part 240 and the latch 200″ is released.

The control part may receive the signal from the second sensor 720 and may determine whether the stopping part 242 is returned to the releasing position.

If it is determined that the stopping part 242 is returned to the releasing position, the control part stops the latch driving part 240.

An operation of the latch driving part 240 may be accurately performed through the second and third sensors 720 and 730.

When the lever disposed at the inner side or the outer side of the door is pulled so as to open the door in the locked state, the door-out-lever connecting part 510 or the door-in-lever connecting part 520 is pulled.

The locked state of the latch 200″ is released, and the latch 200″ is rotated and returned in the counterclockwise direction by the first return spring 250. Therefore, the link 10 may be separated from the latch 200″, and the door may be opened.

The control part receives the signal from the fourth sensor 740 and determines whether the door lever is operated.

If it is determined that the door lever is operated, the control part rotates the latch 200″ in the reverse direction even when the latch driving part 240 is being operated (rotated in the normal direction) to rotate the latch 200″ to the locking position, and thus returns the stopping part 242 to the releasing position.

Therefore, the protrusion 260 of the latch 200″ is not caught by the stopping part 242, and the sliding member 300 is pulled by the operated door lever, and separated from the latch 200″. Thus, the latch 200″ is returned to the releasing position by the first return spring 250.

Accordingly, even in the case in which the door is being automatically closed by the latch driving part 240, if clothing or a person is caught in the door, and the user may pull the door lever, the locked state of the latch is released, and a safety accident may be prevented.

### Third Embodiment

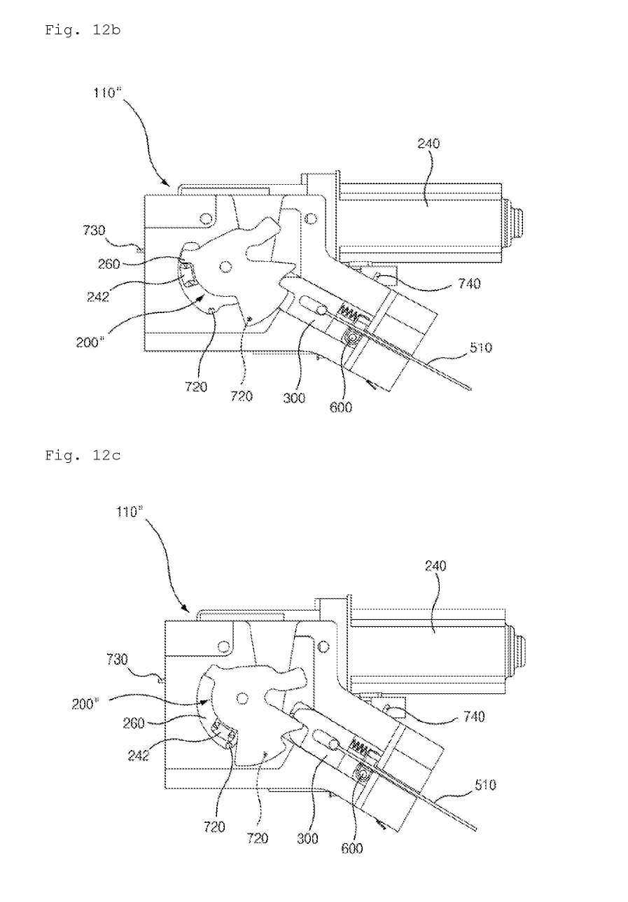

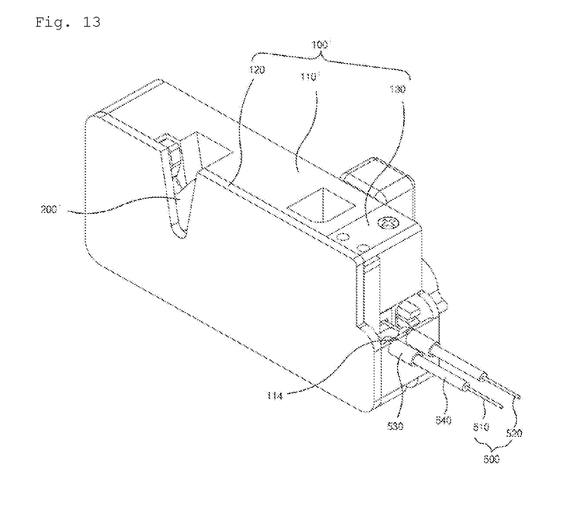

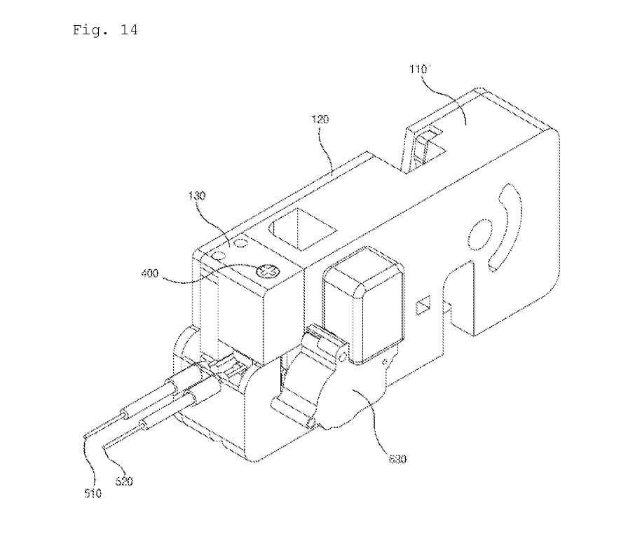

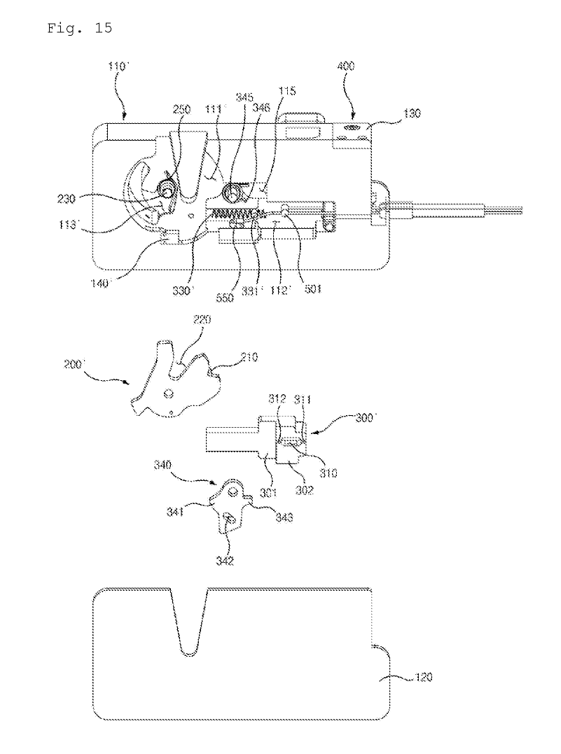

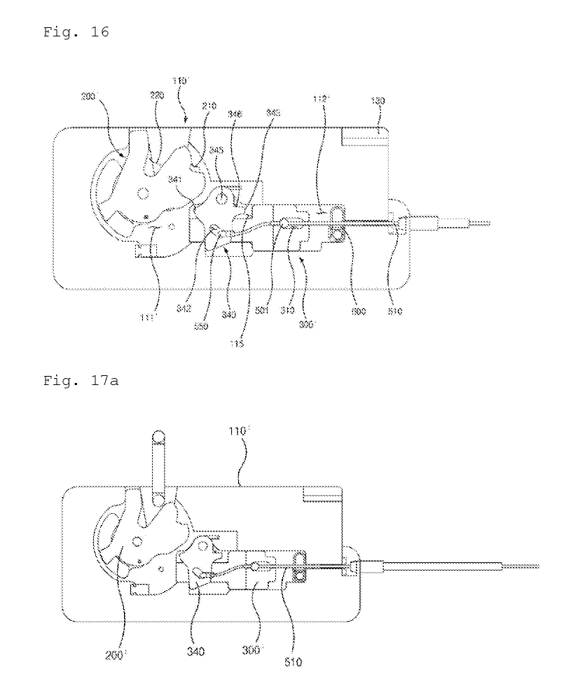

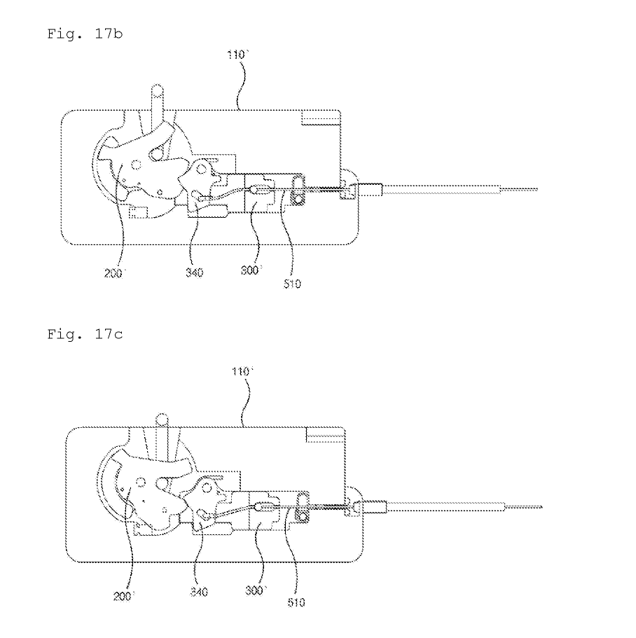

As illustrated in FIGS. 13 to 17, in a latch system for a door in accordance with a third embodiment of the present invention, the locking member includes a rotating member 340 which is rotatably installed at a housing 100′ and a sliding member 300′.

The illustration and description of the elements of the embodiment which are similar to or the same as those in the first embodiment will be omitted.

A groove-shaped spring moving part 113′ in which the first return spring 250 is moved is formed at a front surface of a first housing 110′ to be in communication with a latch seating groove 111′. The spring moving part 113′ is disposed in the latch seating groove 111′.

As illustrated in FIG. 15, a rotating member seating groove 115 is formed at the front surface of the first housing 110′ to be disposed at a right upper portion of the latch seating groove 111′. The rotating member seating groove 115 is in communication with the latch seating groove 111′.

A locking member seating groove 112′ is formed at the front surface of the first housing 110′ to be in communication with the rotating member seating groove 115 and the latch seating groove 111′.

The locking member seating groove 112′ is disposed at a rear side of the rotating member seating groove and a right side of the latch seating groove 111′.

The locking member seating groove 112′ is horizontally disposed in a left and right direction.

Due to these seating grooves, the locking member and the latch 200′ are caught by the first housing 110′ at the locking position and the releasing position and thus prevented from being excessively moved.

A bumper member 140′ is installed at an inner wall of the first housing 110′ to be disposed in the latch seating groove 111′.

The rotating member 340 is formed in a plate shape.

The rotating member 340 is installed at the first housing 110′ via a rotating member rotating shaft 345. Thus, the rotating member 340 is rotatably installed at the first housing 110′.

The rotating member rotating shaft 345 is installed above the rotating member 340.

A locking protrusion 341 which is inserted into the first locking groove 210 or the second locking groove 220 is formed to protrude from a left side of the rotating member 340. Upper and lower portions of the locking protrusion 341 are formed in an arc shape to be inclined. A portion of the latch 200′ which comes into contact with the locking protrusion 341 is formed to correspond to a shape of the locking protrusion 341.

A spring stopping protrusion 343 by which the other end of a rotating member return spring 346 is caught is formed to protrude from a right side of the rotating member 340. One end of the rotating member return spring 346 is connected with the first housing 110′, and the rotating member return spring 346 is inserted onto the rotating member rotating shaft 345, and installed at the first housing 110′. The rotating member return spring 346 provides an elastic force so that the rotating member 340 is rotated to the locking position.

The locking protrusion 341 and the spring stopping protrusion 343 are disposed under the rotating member rotating shaft 345.

A lower portion of the rotating member 340 is caught by the first housing 110′ so as not to be excessively rotated in the clockwise direction.

A lever connecting part coupling part 342 to which an extending link part 550 formed to extend from the first stopping part 501 is coupled is formed at a lower portion of the rotating member 340.

The lever connecting part coupling part 342 is formed in a through-hole shape formed to pass through the rotating member 340 in a forward and backward direction, and also formed to be inclined, such that a height thereof is gradually lowered toward a right side thereof.

The sliding member 300′ includes a thin part 301 disposed at a left side thereof and a thick part 302 disposed at a right side thereof.

The thick part 302 is formed thicker than the thin part 301 to be stepped.

The stopping part seating groove 310 is formed at front and rear surfaces of the thick part long in a left and right direction. The first stopping part 501 is inserted into the stopping part seating groove 310, and the lever connecting part 500 is connected to the sliding member 300′.

Withdrawing holes 311 and 312 are respectively formed at left and right sides of the stopping part seating groove 310 disposed at the front surface, and the door-out-lever connecting part 510 passes through the thick part 302.

The withdrawing hole is formed at only a right side of the stopping part seating groove 310 disposed at the rear surface.

A spring seating groove is formed at a rear surface of the thin part 301 so that a second return spring 330′ is seated therein.

Therefore, a left end of the second return spring 330′ is caught by the sliding member 300′, and a right end thereof is caught by a spring fixing protrusion 331′ installed at the first housing 110′.

The spring fixing protrusion 331′ is also disposed in the spring seating groove.

Meanwhile, as illustrated in FIG. 13, an insertion groove is formed at an outer circumferential surface of an installing cover 530 in a circumferential direction thereof. Also, an installing groove 114 in which the installing cover 530 is inserted is formed at the first housing 110′. The installing groove 114 is formed so that an upper portion thereof is opened. Therefore, when the installing cover 530 is pushed therein from an upper side thereof, the first housing 110′ is inserted into the insertion groove, and thus an assembling operation may be completed. In addition, the cylindrical installing cover 530 is inserted onto a wire of the lever connecting part 500.

A cylindrical guide cover 540 is inserted onto the wire of the lever connecting part 500, and thus the lever connecting part 500 may be smoothly pulled.

Hereinafter, an operation of the embodiment having the above-described structure will be described.

When the user moves the door handle toward the vehicle body, and then inserts the link 10 into the second locking groove 220, the latch 200′ is pushed by the link 10 and rotated in the clockwise direction.

Thus, the locking protrusion 341 of the rotating member 340 is inserted and caught in the first locking groove 210. Therefore, the latch 200′ is in the locked state which may not be rotated in the counterclockwise direction, and the door is in the primarily locked state.

Then, when the user further moves the door toward the vehicle body, the link 10 further rotates the latch 200′ in the clockwise direction.

In this process, the locking protrusion 341 is inserted and caught (engaged) into the second locking groove 220. Therefore, the door is in a secondarily locked state which is completely closed. In the secondarily locked state, an opposite side of the latch 200′ is supported by the bumper member 140′, and the latch 200′ and the rotating member 340 are maintained in a state in which the latch 200′ and the rotating member 340 come into close contact with each other.

Also, in the locking state, the lower portion of the rotating member 340 is caught by the first housing 110′, and thus the rotating member 340 is not rotated in the clockwise direction, but allowed to be rotated in the counterclockwise direction.

When the lever disposed at the inner side or the outer side of the door is pulled so as to open the door in the locked state, the door-out-lever connecting part 510 or the door-in-lever connecting part 520 is pulled.

When the door-out-lever connecting part 510 is pulled, the rotating member 340 is rotated in the counterclockwise direction, and separated from the latch 200′. Therefore, the locked state of the latch 200′ is released, and the latch 200′ is rotated and returned in the counterclockwise direction by the first return spring 250. Thus, the link 10 may be separated from the latch 200′, and the door may be opened.

Also, when the door-in-lever connecting part 520 is pulled, the first stopping part 501 is caught by the sliding member 300′, and thus the sliding member 300′ is also pulled with the door-in-lever connecting part 520. Thus, the rotating member 340 connected to the sliding member 300′ by the door-out-lever connecting part 510 is also pulled and rotated in the counterclockwise direction. Therefore, the locked state of the latch 200′ is released, and the latch 200′ is rotated and returned in the counterclockwise direction by the first return spring.

### Fourth Embodiment

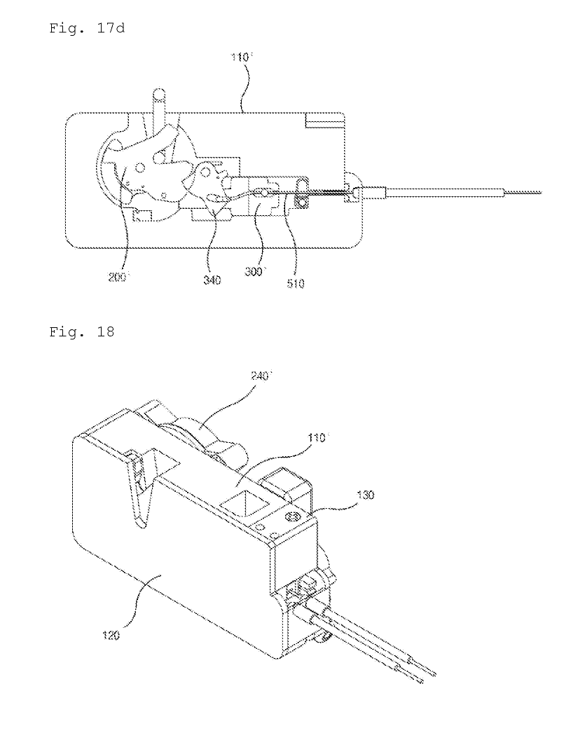

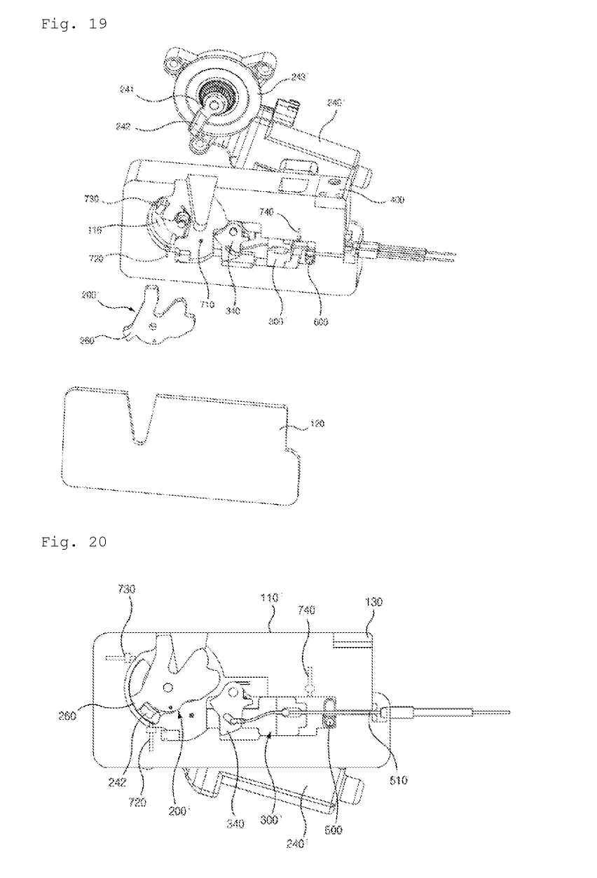

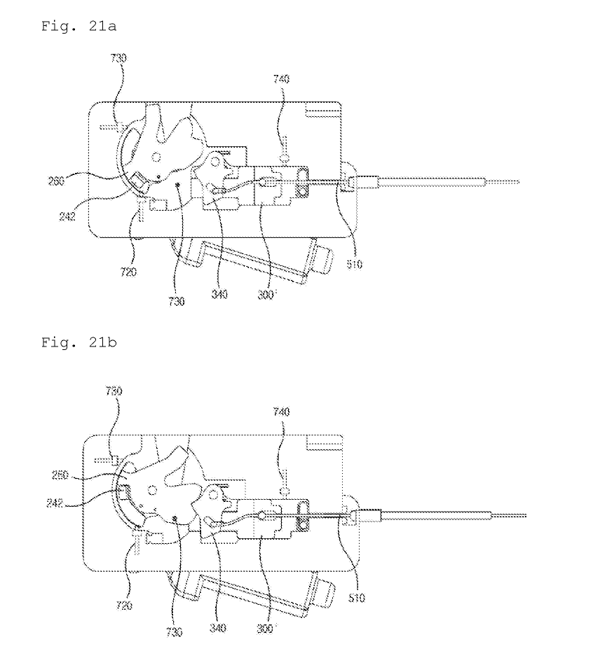

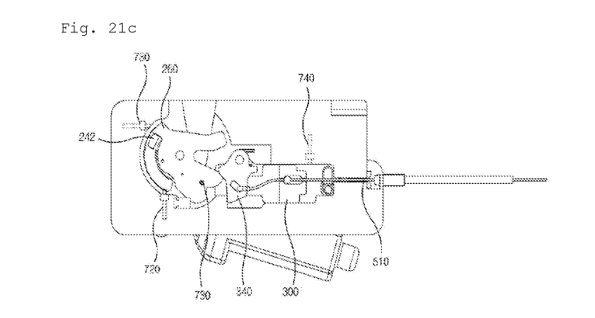

As illustrated in FIGS. 18 to 21, a latch system for a door in accordance with a fourth embodiment of the present invention includes the locking member of the third embodiment, and further includes a latch driving part 240′ which rotates the latch 200′ to the locking position.

The illustration and description of the elements of the embodiment which are similar to or the same as those in the previous embodiments will be omitted.

The latch driving part 240′ is installed at a rear side of the first housing 110′ by a driving part bracket 243′. A coupling part of the driving part bracket 243′ is formed to protrude radially, such that three points of the driving part bracket 243′ are fixed to the first housing 110′.

The first sensor 710 is disposed in the latch seating groove 111′, and the second sensor 720 is disposed under the stopping part guide groove 116, and the third sensor 730 is disposed above the stopping part guide groove 116.

Also, the fourth sensor 740 is disposed above the locking member seating groove 112′ to detect the sliding member 300′.

The protrusion 260 by which the stopping part 242 is caught is formed at a lower portion of a left side of the latch 200′.

Hereinafter, a method of controlling the latch system for the door of the embodiment having the above-described structure will be described.

When the user moves the door handle toward the vehicle body, and then inserts the link 10 into the second locking groove 220, the latch 200″ is pushed by the link 10 and rotated in the clockwise direction.

Thus, the locking protrusion 341 of the rotating member 340 is inserted and caught into the first locking groove 210. Like this, if the latch 200′ is rotated until it is in the primarily locked state, i.e., the latch 200′ is rotated by the predetermined angle, the first sensor 710 is covered by the latch 200′. Therefore, the first sensor 710 detects that the latch 200′ is rotated by the predetermined angle, and transmits a signal to the control part.

The control part to which the signal is transmitted operates the latch driving part 240′ in the normal direction (the clockwise direction). Thus, the stopping part 242 is rotated in the clockwise direction.

Therefore, the protrusion 260 is caught by the stopping part 242, and simultaneously rotated with the stopping part 242. In this process, the locking protrusion 341 is inserted and caught (engaged) into the second locking groove 220. Therefore, the door is in the secondarily locked state which is completely closed.

The control part controls the latch driving part 240′ so that the latch 200′ is rotated to the secondary locking position.

Like this, even when the user lightly closes the door, i.e., the user does not apply a force enough to completely close the door, the door may be automatically closed.

Further, the control part may receive the signal from the third sensor 730, and may determine whether the stopping part 242 is rotated to the locking position.

If it is determined that the stopping part 242 is rotated to the locking position, the control part rotates the latch driving part 240′ in the reverse direction (the counterclockwise direction) and returns the stopping part 242.

Therefore, a connection between the latch driving part 240′ and the latch 200′ is released.

The control part may receive the signal from the second sensor 720, and may determine whether the stopping part 242 is returned to the releasing position.

If it is determined that the stopping part 242 is returned to the releasing position, the control part stops the latch driving part 240′.

An operation of the latch driving part 240′ may be accurately performed through the second and third sensors 720 and 730.

When the lever disposed at the inner side or the outer side of the door is pulled so as to open the door in the locked state, the door-out-lever connecting part 510 or the door-in-lever connecting part 520 is pulled.

Therefore, the rotating member 340 is rotated in the counterclockwise direction, and the locked state of the latch 200′ is released, and the latch 200′ is rotated and returned in the counterclockwise direction by the first return spring 250. Therefore, the link 10 may be separated from the latch 200′, and the door may be opened.

The control part receives the signal from the fourth sensor 740 and determines whether the door lever is operated.

If it is determined that the door lever is operated, the control part rotates the latch 200′ in the reverse direction, even when the latch driving part 240′ is being operated (rotated in the normal direction) to rotate the latch 200′ to the locking position, and thus returns the stopping part 242 to the releasing position.

Therefore, the protrusion 260 of the latch 200′ is not caught by the stopping part 242, and the rotating member 340 is also pulled by the operated door lever and separated from the latch 200′. Thus, the latch 200′ is returned to the releasing position by the first return spring 250.

Accordingly, even in the case in which the door is being automatically closed by the latch driving part 240′, if clothing or a person is caught in the door, and the user pulls the door lever, the locked state of the latch is released, and a safety accident may be prevented.

Although a few embodiments of the present invention have been shown and described, it would be appreciated by those skilled in the art that changes may be made in these embodiments without departing from the principles and spirit of the invention, the scope of which is defined in the claims and their equivalents.

Description of Symbols

| | |
|---|---|
| 100: housing | 200: latch |
| 300: sliding member | 400: second safety device |
| 600: first safety device | 500: lever connecting part |

1. A latch system for a door comprising:
a housing;
a latch rotatably installed at the housing; and
a locking member installed at the housing to lock the latch,
wherein the locking member comprises a sliding member slidably installed at the housing, and the latch is installed to be rotatable, and the sliding member is installed to be linearly movable.

2. The latch system of claim 1, wherein a lever connecting part connected to a door lever to slide the sliding member is connected to the sliding member, and a moving space in which the lever connecting part is movable in a pulling direction is formed at the sliding member.

3. The latch system of claim 2, wherein the latch is disposed at one side of the sliding member, a first safety device is rotatably installed at the housing, and the first safety device is disposed at the other side of the sliding member to fix the door lever even when the door lever is pulled.

4. The latch system of claim 2, wherein the lever connecting part comprises a door-in-lever connecting part and a door-out-lever connecting part, and a second safety device is rotatably installed at the housing, and a first stopping part caught by the sliding member and a second stopping part caught by the second safety device are formed at the door-in-lever connecting part.

5. The latch system of claim 4, further comprising a second safety driving part configured to rotate the second safety device.

6. The latch system of claim 1, wherein the locking member further comprises a rotating member rotatably installed at the housing and a lever connecting part connected to a door lever, a locking groove is formed at the latch, a locking protrusion inserted into the locking groove is formed at the rotating member, and the lever connecting part is connected to the rotating member and the sliding member so as to rotate the rotating member and to slide the sliding member.

7. The latch system of claim 1, further comprising a latch driving part configured to rotate the latch to a locking position.

8. The latch system of claim 7, comprising a first sensor configured to detect whether the latch is rotated by a predetermined angle, and a control part configured to receive a signal from the first sensor and to rotate the latch to the locking position through the latch driving part.

9. The latch system of claim 7, wherein a protrusion is formed at the latch, a stopping part caught by the protrusion is formed at the latch driving part, and a second sensor configured to detect whether the stopping part is returned to a releasing position and a third sensor configured to detect whether the stopping part is rotated to a locking position are provided.

10. The latch system of claim 8, further comprising a fourth sensor configured to detect whether the door lever is operated, wherein, when an operation of the door lever is detected through the fourth sensor, the control part returns the latch to the releasing position even though the latch driving part is being operated.

11. A latch system for a door, comprising:
a housing:
a latch rotatably installed at the housing and having a locking groove formed therein;
a latch driving part configured to rotate the latch to a locking position;
a locking member installed at the housing to lock the latch; and
a lever connecting part connected to a door lever,
wherein the locking member comprises a rotating member rotatably installed at the housing and having a locking protrusion inserted into the locking groove and a sliding member slidably installed at the housing, the latch is installed to be rotatable, and the sliding member is installed to be linearly movable, and the lever connecting part is connected to the rotating member and the sliding member so as to rotate the rotating member and to slide the sliding member.

12. The latch system of claim 1, wherein the latch is disposed at one side of the sliding member, a first safety device is rotatably installed at the housing, and the first safety device is disposed at the other side of the sliding member to fix the door lever even when the door lever is pulled.

13. The latch system of claim 2, further comprising a latch driving part configured to rotate the latch to a locking position.

14. The latch system of claim 13, comprising a first sensor configured to detect whether the latch is rotated by a predetermined angle, and a control part configured to receive a signal from the first sensor and to rotate the latch to the locking position through the latch driving part.

15. The latch system of claim 13, wherein a protrusion is formed at the latch, a stopping part caught by the protrusion is formed at the latch driving part, and a second sensor configured to detect whether the stopping part is returned to a releasing position and a third sensor configured to detect whether the stopping part is rotated to a locking position are provided.

16. The latch system of claim 14, further comprising a fourth sensor configured to detect whether the door lever is operated, wherein, when an operation of the door lever is detected through the fourth sensor, the control part returns the latch to the releasing position even though the latch driving part is being operated.
